(19) United States
(12) Patent Application Publication
(10) Pub. No.: US 2010/0224044 A1
(43) Pub. Date: Sep. 9, 2010

(54) PROTECTIVE COVER ASSEMBLY WITH A QUICK RELEASE MECHANISM

(75) Inventor: Kuan-Hui Lee, Taichung (TW)

Correspondence Address: K&L Gates LLP, STATE STREET FINANCIAL CENTER, One Lincoln Street, BOSTON, MA, 02111-2950, US

(73) Assignee: P & F BROTHER INDUSTRIAL CORPORATION, Taichung (TW)

(21) Appl. No.: 12/397,743

(22) Filed: Mar. 4, 2009

(51) Int. Cl. B26D 1/14

(52) U.S. Cl. 83/478

(57) ABSTRACT

A protective cover assembly includes a cover unit and a support plate unit. The cover unit includes an elongated hollow cover-mounting seat, two protective covers disposed on said cover-mounting seat, a positioning mechanism, and a quick release mechanism. The positioning mechanism includes front and rear positioning members disposed fixedly in a receiving chamber in the cover-mounting seat, and an abutment member disposed in an upper end of the receiving chamber. The quick release mechanism includes a cam lever and a resilient member. The cam lever is pivotable relative to the cover-mounting seat between a locking position whereat a lever-engaging unit of the support plate unit is clamped between the abutment member and the cam lever, and a release position whereat the cam lever is removed from the lever-engaging unit.

### BACKGROUND OF THE INVENTION

1. Field of the Invention

This invention relates to a protective cover for a cutting machine, and more particularly to a protective cover assembly that includes a quick release mechanism for connecting a support plate to a cover-mounting seat.

2. Description of the Related Art

Referring to FIG. 1, a first conventional protective cover assembly 10 for a cutting machine (e.g., a sawing machine) includes a cover-mounting seat 11, two protective covers 12 disposed respectively on two opposite sides of the cover-mounting seat 11, and a quick release mechanism 13 disposed in a rear end of the cover-mounting seat 11. Each of the protective covers 12 is pivotable relative to the cover-mounting seat 11 about a rotating shaft 121, and is formed with a slide slot 122 disposed in front of the rotating shaft 121. Two guide pins 14 are connected fixedly to the cover-mounting seat 11, and extend respectively and slidably through the slide slots 122 in the protective covers 12. A support plate 1 is inserted into the cover-mounting seat 11, and is locked on the same by the quick release mechanism 13. With further reference to FIGS. 2 and 3, the cover-mounting seat 11 has a receiving chamber 111, and front and rear slide slots 112, 113, each of which has two closed ends. The quick release mechanism 13 includes a positioning rod 131 disposed fixedly on the cover-mounting seat 11, a movable pressing lever 132 disposed in the receiving chamber 111, and a connecting rod 133 having a front end connected pivotally to the pressing lever 132 by a pivot pin 135. Front and rear sliding rods 134, 136 are disposed respectively and movably within the front and rear slide slots 112, 113 in the cover-mounting seat 11. The rear sliding rod 136 extends rotatably through a rear end of the connecting rod 133. As such, the pressing lever 132 is changeable between a locking position shown in FIG. 3 and a release position shown in FIGS. 1 and 2. In the locking position, the front sliding rod 134 is moved into a retaining groove 101 in the support plate 1 to thereby prevent removal of the support plate 1 from the cover-mounting seat 11. In the release position, the front sliding rod 134 is removed from the retaining groove 101 to thereby allow removal of the support plate 1 from the cover-mounting seat 11. Since the quick release mechanism 13 has a substantial number of components, the manufacturing and assembly costs of the first conventional protective cover assembly 10 are increased.

Referring to FIG. 4, a second conventional protective cover assembly 20 includes a cover-mounting seat 21, two protective covers 22 disposed respectively on two opposite sides of the cover-mounting seat 21, and a quick release mechanism 23 disposed in a rear end of the cover-mounting seat 21. The quick release mechanism 23 is also used to connect a support plate 2 to the cover-mounting seat 21. The support plate 2 has an upper periphery formed with a pair of front and rear positioning notches 201. With further reference to FIGS. 5 and 6, the cover-mounting seat 21 has a receiving chamber 211 in the rear end thereof, and an inclined cam surface 212. The quick release mechanism 23 includes a positioning pin 231 disposed fixedly in a rear portion of the receiving chamber 211 in the cover-mounting seat 21, a retaining rod 232 extending along a transverse direction (B), and a cam lever 233 disposed pivotally on the cover-mounting seat 21. The retaining rod 232 extends fixedly through an intermediate portion of the cam lever 233. The cam lever 233 is formed with an inclined engaging surface 234 in contact with the inclined cam surface 212 of the cover-mounting seat 21. To lock the support plate 2 on the cover-mounting seat 21, the support plate 2 is first inserted into the receiving chamber 211 in the cover-mounting seat 21 such that the positioning pin 231 engages the rear positioning notch 201 in the support plate 2. Next, the cam lever 233 is pivoted to slide the inclined engaging surface 234 on the inclined cam surface 212 to thereby move the retaining rod 232 into the front positioning notch 201 in the support plate 2 along the transverse direction (B) so as to confine a portion of the support plate 2 between the retaining rod 232 and the positioning pin 231. The second conventional protective cover assembly 20 has a drawback. That is, no effective positioning mechanism is provided between the support plate 2 and the cover-mounting seat 21, thereby affecting adversely smooth engagement of the retaining rod 232 and the front positioning notch 201.

### SUMMARY OF THE INVENTION

The object of this invention is to provide a protective cover assembly for a cutting machine that can overcome the above-mentioned drawbacks associated with the prior art.

According to this invention, a protective cover assembly includes a cover unit and a support plate unit. The cover unit includes an elongated hollow cover-mounting seat, two protective covers disposed on said cover-mounting seat, a positioning mechanism, and a quick release mechanism. The positioning mechanism includes front and rear positioning members disposed fixedly in a receiving chamber in the cover-mounting seat, and an abutment member disposed in an upper end of the receiving chamber. The quick release mechanism includes a cam lever and a resilient member. The cam lever is pivotable relative to the cover-mounting seat between a locking position whereat a lever-engaging unit of the support plate unit is clamped between the abutment member and the cam lever, and a release position whereat the cam lever is removed from the lever-engaging unit.

As such, the cam lever is simple in structure.

Furthermore, due to the presence of the positioning mechanism, the lever-engaging unit can be clamped accurately between the abutment member and the cam lever to thereby lock the support plate securely on the cover-mounting seat.

### BRIEF DESCRIPTION OF THE DRAWINGS

These and other features and advantages of this invention will become apparent in the following detailed description of a preferred embodiment of this invention, with reference to the accompanying drawings, in which:

FIGS. 1 and 2 are schematic side views of a first conventional protective cover assembly for a cutting machine, illustrating a pressing lever in a release position;

FIG. 3 is a view similar to FIG. 2 but illustrating the pressing lever in a locking position;

FIG. 4 is a schematic side view of a second conventional protective cover assembly for a cutting machine;

FIG. 5 is a schematic side view of the second conventional protective cover assembly, illustrating how a portion of a support plate is confined between a retaining rod and a positioning pin;

FIG. 6 is a sectional view taken along line VI-VI in FIG. 5;

FIG. 7 is an exploded perspective view of the preferred embodiment of a protective assembly according to this invention;

FIG. 8 is a schematic side view of the preferred embodiment, a protective cover being removed to illustrate a cam lever in a release position;

FIG. 9 is a sectional view taken along line IX-IX in FIG. 8, illustrating how a front insert end portion of a support plate is inserted through a plate-engaging slot in a cover-mounting seat and how a rear positioning member is disposed on the cover-mounting seat;

FIG. 10 is a sectional view taken along line X-X in FIG. 8, illustrating how a cam lever, a spacer ring, and a resilient member are disposed on a pivot pin between two sidewalls of the cover-mounting seat;

FIG. 11 is a partly exploded side view of the cover-mounting seat, the support plate, and the protective cover of the preferred embodiment; and

FIG. 12 is a view similar to FIG. 8 but illustrating the cam lever in a locking position.

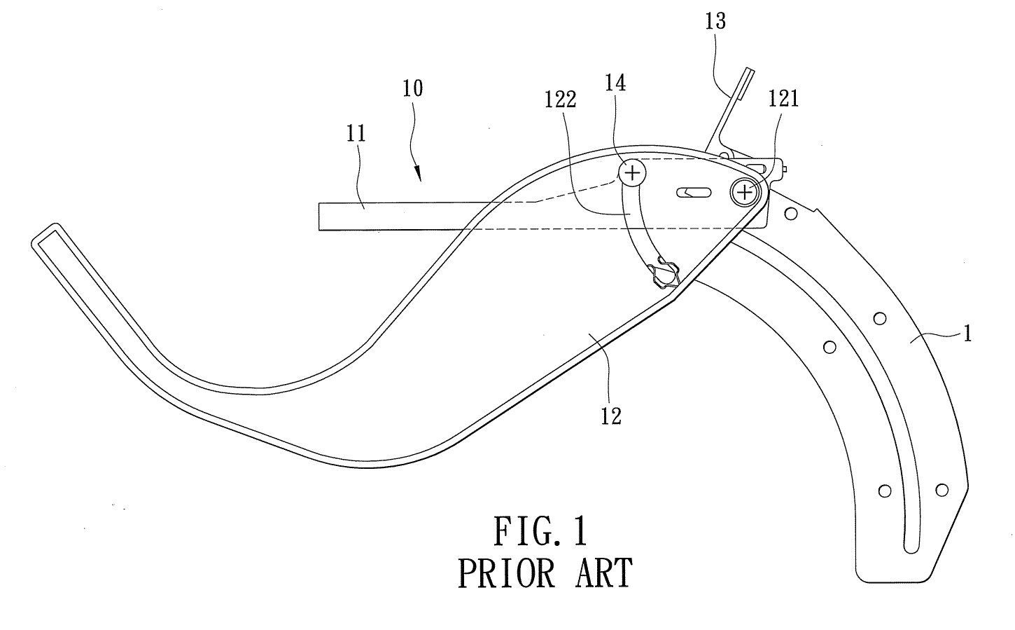

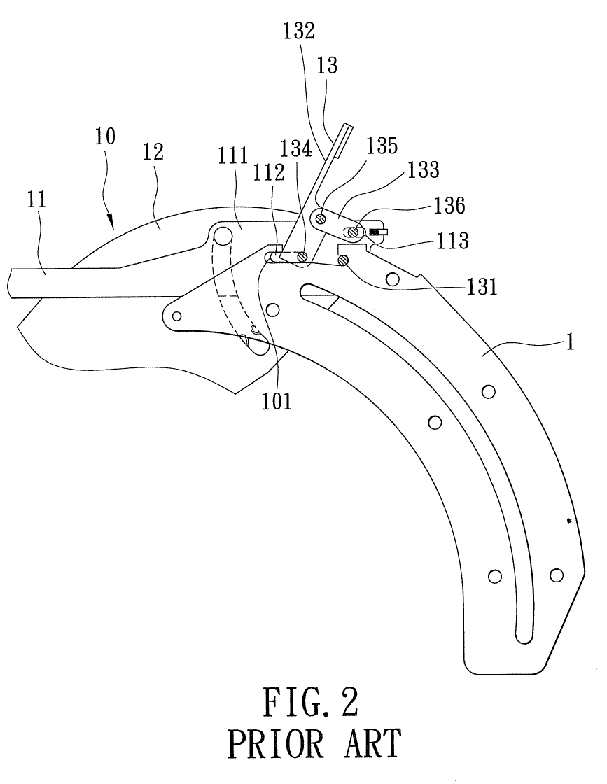

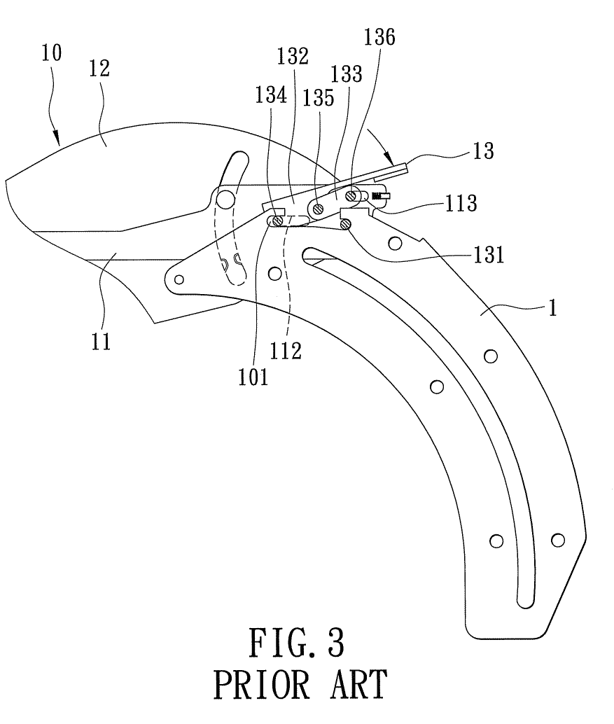

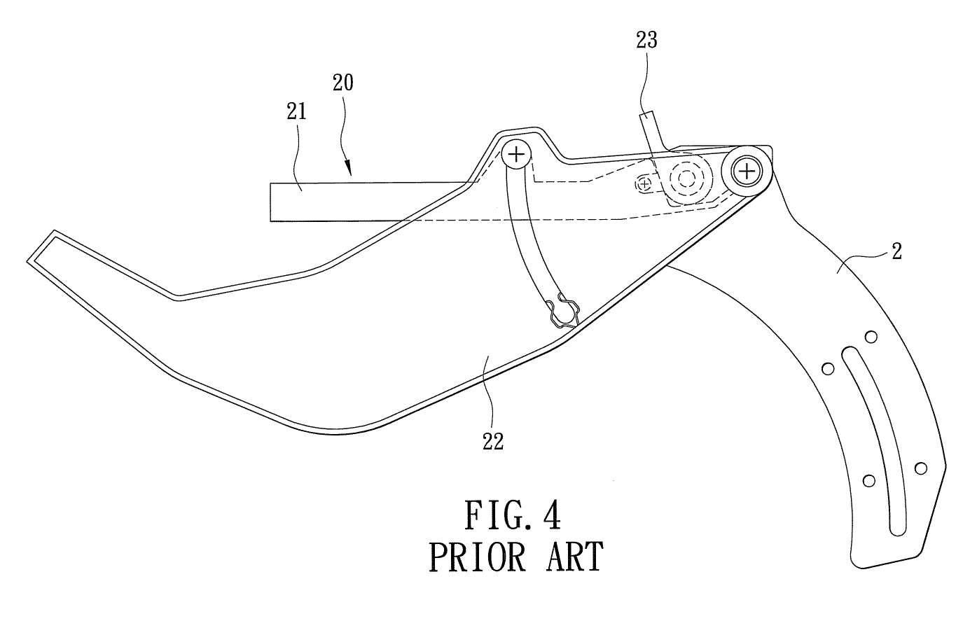

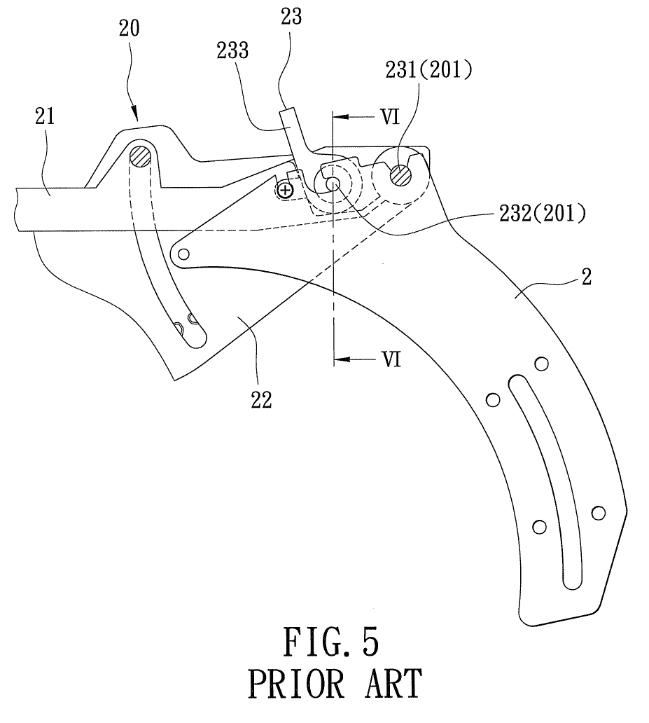

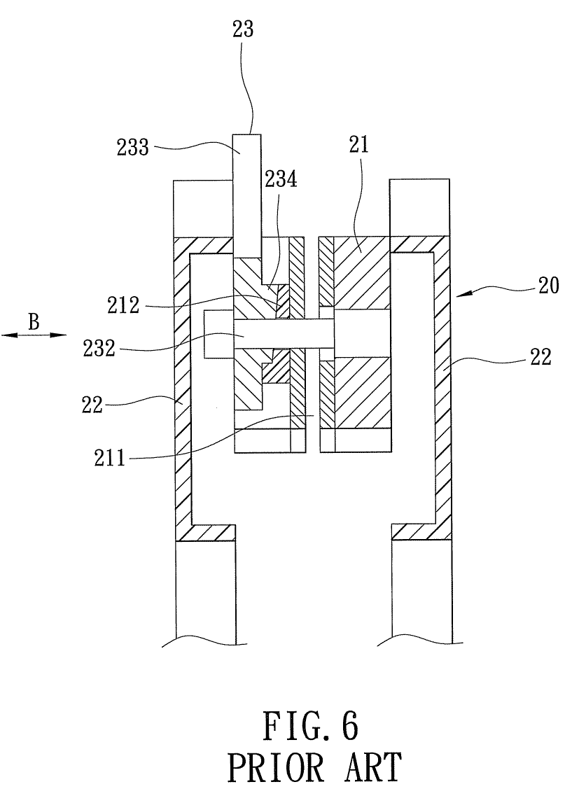

### DETAILED DESCRIPTION OF THE PREFERRED EMBODIMENT

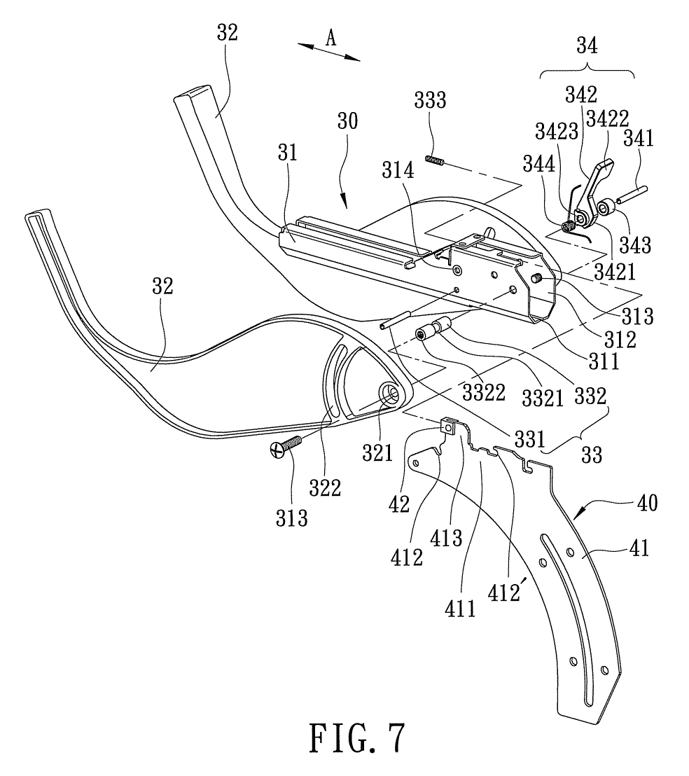

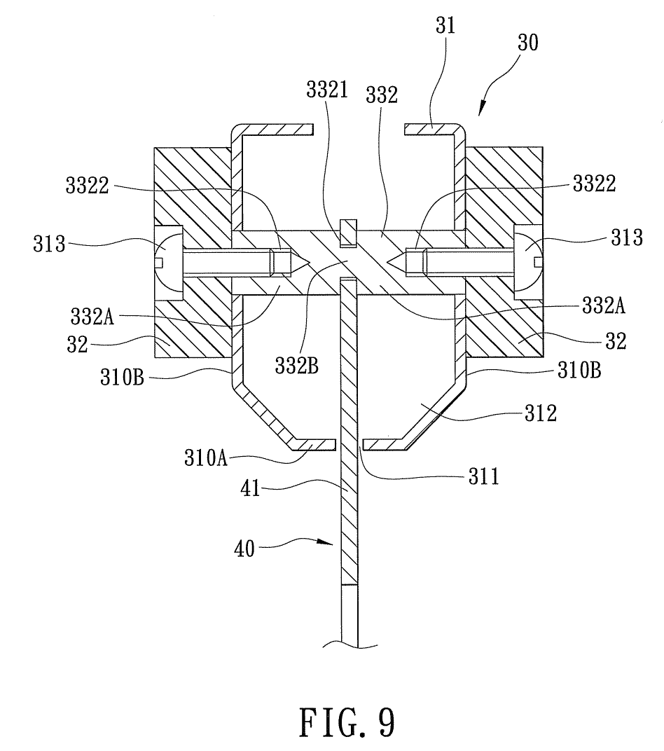

Referring to FIGS. 7, 8, and 9, the preferred embodiment of a protective cover assembly according to this invention includes a cover unit 30 and a support plate unit 40.

The cover unit 30 includes an elongated hollow cover-mounting seat 31, two protective covers 32 disposed respectively on two opposite sides of the cover-mounting seat 31, a positioning mechanism 33 disposed in the cover-mounting seat 31, and a quick release mechanism 34 disposed on an upper end portion of the cover-mounting seat 31.

The cover-mounting seat 31 includes a bottom wall 310A formed with an open-ended plate-engaging slot 311 extending rearwardly from a rear end of the bottom wall 310A along a longitudinal direction (A) of the cover-mounting seat 31, and a receiving chamber 312 formed in a rear end portion of the cover-mounting seat 31 and in spatial communication with the plate-engaging slot 311. Two pivot bolts 313 extend respectively through pivot holes 321 in rear ends of the protective covers 32, and are connected to the cover-mounting seat 31 so as to allow for upward and downward pivoting movement of the protective covers 32 relative to the cover-mounting seat 31.

Each of the protective covers 32 is formed with a curved slide slot 322 in front of the corresponding pivot hole 321. Two guiding members 314 are disposed fixedly on the cover-mounting seat 31, and engage respectively and slidably the slide slots 322 in the protective covers 321.

The positioning mechanism 33 includes a pair of front and rear positioning members 331, 332 disposed fixedly in the receiving chamber 312 in the cover-mounting seat 31 such that the front positioning member 331 is located in front of the rear positioning member 332, and an abutment member 333 disposed adjustably in an upper end of the receiving chamber 312 and adjustable in position relative to the cover-mounting seat 31 along the longitudinal direction (A). Each of the front and rear positioning members 331, 332 extends along a transverse direction perpendicular to the longitudinal direction (A). The front positioning member 331 has a C-shaped cross-section. The rear positioning member 332 has two large-diameter end portions 332A and a small-diameter middle portion 332B connected between the large-diameter end portions 332A and having a diameter smaller than that of each of the diameter end portions 332A to define an annular groove 3321 between the large-diameter end portions 332A. The rear positioning member 332 further has two end surfaces formed respectively with two threaded holes 3322. The pivot bolts 314 extend respectively through two sidewalls 310B of the cover-mounting seat 31, and engage respectively the threaded holes 3322 in the end surfaces of the rear positioning member 332. The abutment member 333 is configured as an adjustment bolt extending along the longitudinal direction (A) and formed with a hexagonal hole 3331 in a front end surface thereof.

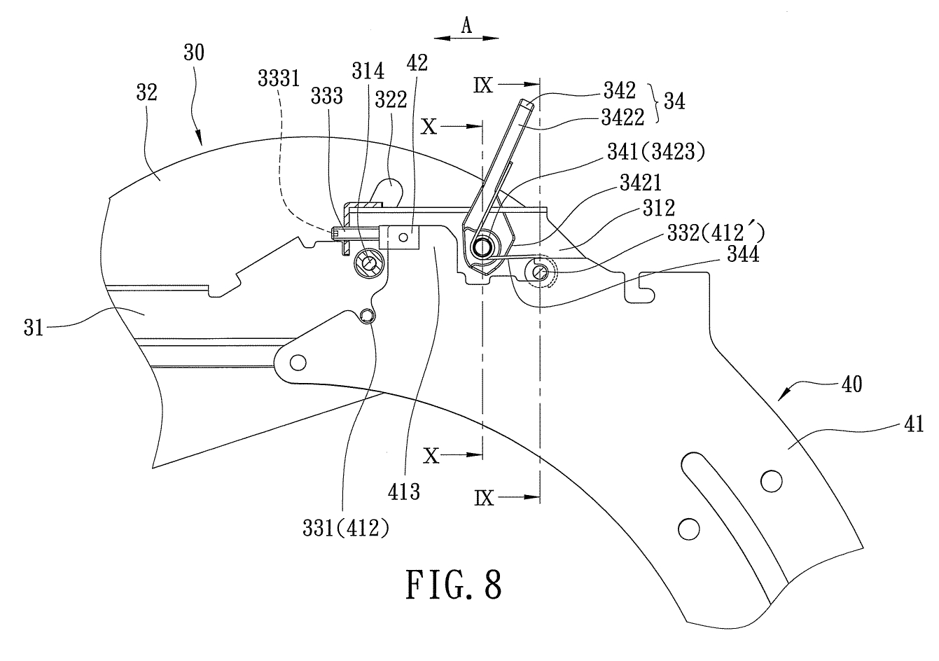

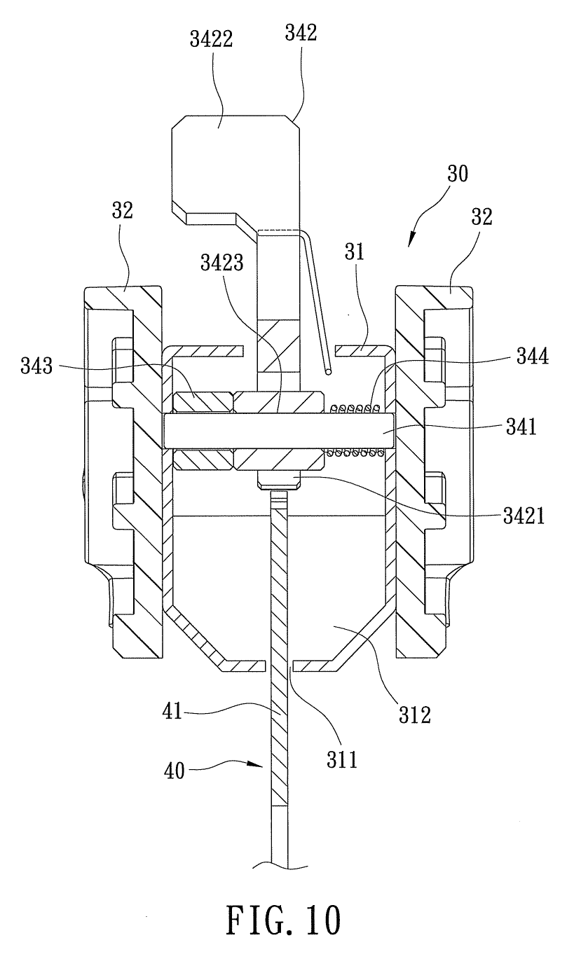

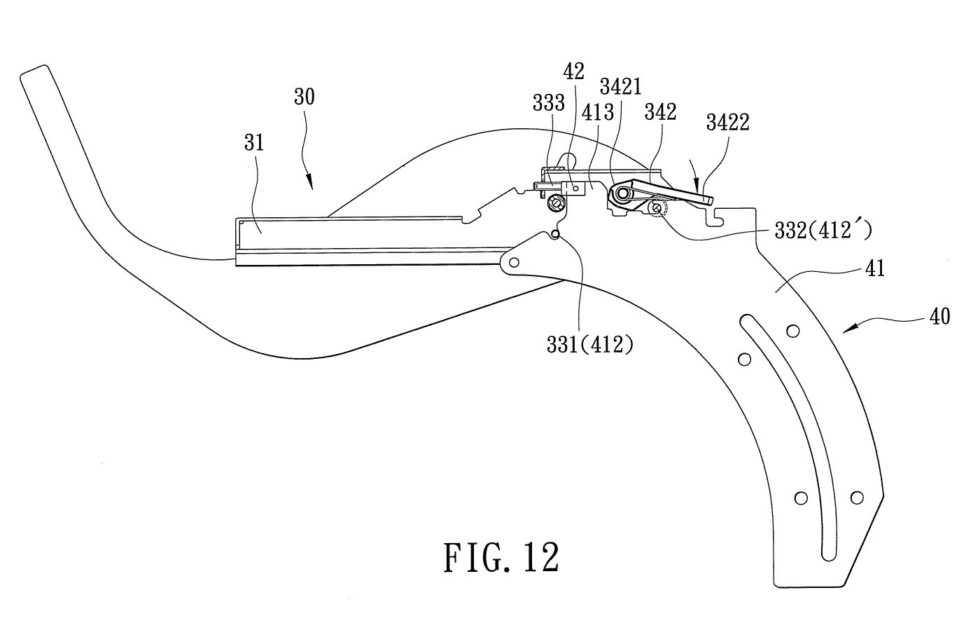

With further reference to FIG. 10, the quick release mechanism 34 includes a pivot pin 341, a cam lever 342, a spacer ring 343, and a resilient member 344. The pivot pin 341 is disposed in the receiving chamber 312 in the cover-mounting seat 31, and extends through the sidewalls 310B. The cam lever 342 has a cam portion 3421 disposed behind the abutment member 333, a lever portion 3422 connected to the cam portion 3421, and a pivot hole 3423 formed through the cam portion 3421 and permitting extension of the pivot pin 341 therethrough such that the cam lever 342 is sleeved rotatably on a middle portion of the pivot pin 341 between the sidewalls 310B. The cam lever 342 is pivotable relative to the cover-mounting seat 341 between a release position shown in FIG. 8 and a locking position shown in FIG. 12.

The spacer ring 343 is sleeved on the pivot pin 341, and has two ends abutting respectively against the cam portion 3421 of the cam lever 342 and one of the sidewalls 310B. The resilient member 344 is sleeved on the pivot pin 341, and is disposed between the cam portion 3421 of the cam lever 342 and the other of the sidewalls 310B. The resilient member 344 is configured as a coiled torsion spring, and is used for biasing the cam lever 342 toward the release position.

The support plate unit 40 includes a support plate 41 and a stop block 42. The support plate 41 has a front insertion end portion 411 extending through the plate-engaging slot 311 in the bottom plate 310A of the cover-mounting seat 31, an outer periphery formed with a pair of spaced-apart front and rear positioning notches 412, 412′ engaging respectively the front positioning member 331 and the small-diameter middle portion 332B of the rear positioning member 332 such that the support plate 41 extends into the annular groove 3321, and a protrusion 413 disposed between the abutment member 333 and the cam portion 3421 of the cam lever 342. When the cam lever 342 is disposed in the locking position, the lever portion 3422 of the cam lever 342 abuts against the support plate 41, as shown in FIG. 12. When the cam lever 342 is disposed in the release position, the lever portion 3422 of the cam lever 342 is removed from the support plate 41, as shown in FIG. 8.

The stop block 42 is made of an anti-wear plastic material, is riveted to the projection 413 of the support plate 41, and cooperates with the same to constitute a lever-engaging unit such that the stop block 42 is disposed at a front end of the lever-engaging unit. The abutment member 333 abuts against the stop block 42. When the cam lever 342 is disposed in the release position, the cam portion 3421 of the cam lever 342 is spaced apart from the lever-engaging unit to allow for removal of the support plate 41 from the cover-mounting seat 31. When the cam lever 342 is disposed in the locking position, the cam portion 3421 of the cam lever 342 is in contact with the lever-engaging unit to prevent movement of the lever-engaging unit relative to the cover-mounting seat 31 and, thus, removal of the support plate 41 from the cover-mounting seat 31.

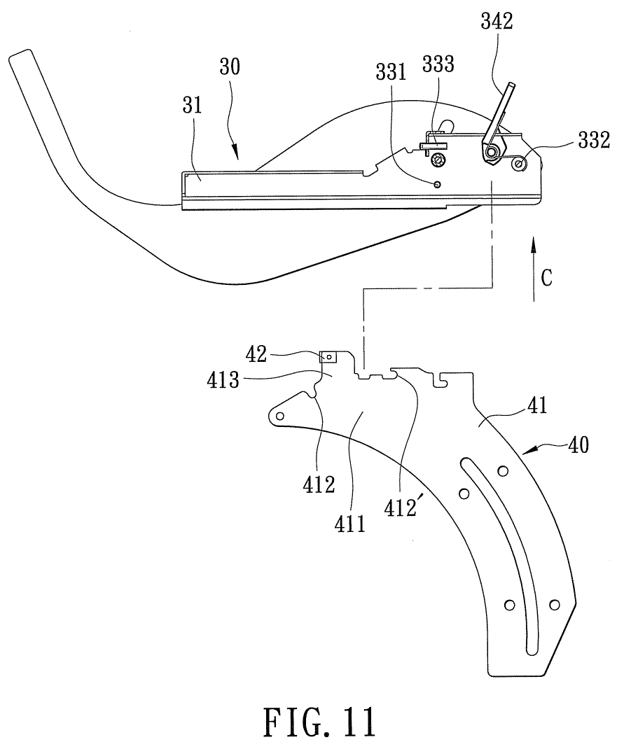

During assembly, the front insertion end portion 411 of the support plate 41 is inserted into the cover-mounting seat 31 in an upward direction (C) (see FIG. 11) so as to engage the front and rear positioning notches 412, 412′ with the front and rear positioning members 331, 332, respectively, and so as to allow the stop block 42 to abut against the abutment member 333, as shown in FIG. 8. Subsequently, the cam lever 342 is pivoted downwardly until it comes into contact with the support plate 41 (i.e., the cam lever 342 is pivoted to the locking position), as shown in FIG. 12. Hence, the lever-engaging unit is clamped between the abutment member 333 and the cam portion 3421 of the cam lever 342 to lock the support plate 41 on the cover-mounting seat 31.

The protective cover assembly of this invention has the following advantages:
(1) The quick release mechanism 34 is simple in structure.
(2) Due to the presence of the positioning mechanism 33, the lever-engaging unit can be clamped accurately between the abutment member 333 and the cam portion 3421 of the cam lever 342 to thereby lock the support plate 41 securely on the cover-mounting seat 31.

With this invention thus explained, it is apparent that numerous modifications and variations can be made without departing from the scope and spirit of this invention. It is therefore intended that this invention be limited only as indicated by the appended claims.

I claim:

1. A protective cover assembly comprising:
a cover unit including an elongated hollow cover-mounting seat, two protective covers disposed respectively on two opposite sides of said cover-mounting seat, a positioning mechanism disposed in said cover-mounting seat, and a quick release mechanism disposed on an upper end portion of said cover-mounting seat, said cover-mounting seat including a bottom wall formed with an open-ended plate-engaging slot extending forwardly from a rear end of said bottom wall along a longitudinal direction of said cover-mounting seat, and a receiving chamber formed in a rear end portion of said cover-mounting seat and in spatial communication with said plate-engaging slot, said positioning mechanism including a pair of front and rear positioning members disposed fixedly in said cover-mounting seat such that said front positioning member is located in front of said rear positioning member, and an abutment member disposed in an upper end of said receiving chamber in said cover-mounting seat, said quick release mechanism including a cam lever and a resilient member, said cam lever having a cam portion disposed behind said abutment member, and a lever portion connected to said cam portion, said cam lever being pivotable relative to said cover-mounting seat between a locking position and a release position, said resilient member being disposed for biasing said cam lever to pivot toward said release position; and
a support plate unit including a support plate having a front insertion end portion extending through said plate-engaging slot in said bottom wall of said cover-mounting seat, and an outer periphery formed with a pair of spaced-apart front and rear positioning notches engaging respectively said front and rear positioning members of said positioning mechanism, said support plate unit including a lever-engaging unit disposed between said abutment member of said positioning mechanism and said cam portion of said cam lever of said quick release mechanism and having a front end abutting against said abutment member, said lever-engaging unit being clamped between said abutment member and said cam portion so as to prevent removal of said support plate from said cover-mounting seat when said cam lever is disposed in said locking position, said cam portion being removed from said lever-engaging unit so as to allow for removal of said support plate from said cover-mounting seat when said cam lever is disposed in said release position.

2. The protective cover assembly as claimed in claim 1, wherein said support plate further has a protrusion disposed between said abutment member and said cam portion of said cam lever, said support plate unit further including a stop block disposed fixedly on said projection of said support plate and constituting said front end of said lever-engaging unit, said abutment member being configured as an adjustment bolt abutting against said stop block, said adjustment bolt extending along the longitudinal direction and being adjustable in position relative to said cover-mounting seat along the longitudinal direction, said stop block cooperating with said projection of said support plate to constitute said lever-engaging unit.

3. The protective cover assembly as claimed in claim 1, wherein said rear positioning member has two large-diameter end portions and a small-diameter middle portion connected between said large-diameter end portions and having a diameter smaller than that of each of said large-diameter end portions to define an annular groove between said large-diameter end portions, said support plate extending into said annular groove such that said small-diameter middle portion engages said rear positioning notch in said support plate.

4. The protective cover assembly as claimed in claim 3, wherein said cover-mounting seat further has two sidewalls, said rear positioning member further having two end surfaces formed respectively with two threaded holes, said cover-mounting seat further including two bolts extending respectively through said sidewalls of said cover-mounting seat and engaging respectively said threaded holes in said rear positioning members.

5. The protective cover assembly as claimed in claim 1, wherein each of said front and rear positioning members extends along a transverse direction perpendicular to the longitudinal direction of said cover-mounting seat.

6. The protective cover assembly as claimed in claim 1, wherein said cover-mounting seat further has two sidewalls, said quick release mechanism further including a pivot pin extending through said sidewalls of said cover-mounting seat, said cam portion of said cam lever being sleeved rotatably on a middle portion of said pivot pin and disposed between said sidewalls of said cover-mounting seat, said resilient member being sleeved on said pivot pin and disposed between said cam portion of said cam lever and one of said sidewalls, said positioning mechanism further including a spacer ring sleeved on said pivot pin and having two ends abutting respectively against said cam portion of said cam lever and the other of said sidewalls.
